(19) United States
(12) Patent Application Publication
(10) Pub. No.: US 2007/0086928 A1
(43) Pub. Date: Apr. 19, 2007

(54) Devices and Methods for Biological Sample Preparation

(75) Inventor: Donald R. Sandell, San Jose, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/551,165

(22) Filed: Oct. 19, 2006

Related U.S. Application Data
(63) Continuation of application No. 10/360,006, filed on Feb. 6, 2003.

(51) Int. Cl. B01L 3/00

(52) U.S. Cl. 422/102

(57) ABSTRACT

A sample preparation system for preparing a biological sample for testing is provided. The preparation system may include a sample preparation chamber including a biological sample, a waste collection chamber for storing waste liquid, a sample substrate, and a fluid management module. The fluid management module may be configured to selectively connect between two of the sample preparation chamber, the waste collection chamber, and the sample substrate in fluid communication. Methods of filling a sample substrate with a biological sample are also provided.

### FIELD

The present teachings relate to devices and methods for biological testing. In particular, the present teachings relate to devices and methods for preparation of biological samples for testing.

### BACKGROUND

Biological testing has become an important tool in detecting and monitoring diseases. In the biological testing field, thermal cycling is used to amplify nucleic acids by, for example, performing polymerase chain reaction (PCR) or other reactions. The discovery of the PCR process has completely revolutionized the biological detection and testing methods and has quickly become a standard technique in many applications such as cloning, analysis of genetic expression, DNA sequencing, and drug discovery. In a PCR process, for example, a specific target DNA is amplified in a relatively short period of time, permitting a rapid detection and visualization of the amplified DNA sequence. In addition, sample analysis can be performed simultaneously with thermal cycling in real time by using any suitable real-time detection device. One example of a real-time detection device is the scanning device disclosed in a co-pending U.S. application Ser. No. 09/617,549 by Mark F. Oldham, filed Jul. 14, 2000, entitled “SCANNING SYSTEM AND METHOD FOR SCANNING A PLURALITY OF SAMPLES,” assigned to the assignee of the present teachings, the disclosure of which is hereby incorporated by reference. Any number of other real-time detection devices may also be suitable.

### SUMMARY OF THE TEACHINGS

Various embodiments generally relate to, among other things, a biological sample preparation system. According to various aspects, the biological sample preparation system may include a sample preparation chamber comprising a biological sample, a waste collection chamber for storing waste liquid, a sample substrate, and a fluid management module for selectively connecting between two of the sample preparation chamber, the waste collection chamber, and the sample substrate in fluid communication.

Various embodiments relate to a method for filling a sample substrate may comprise introducing a biological sample in a sample preparation chamber, providing a movable fluid management module having an internal volume with a first fluid port and a second fluid port, moving the fluid management module to align one of the first and second fluid ports with the sample preparation chamber in fluid communication, transporting the biological sample from the sample preparation chamber to the internal volume via the one of the first and second fluid ports, moving the fluid management module to align one of the first and second fluid ports with a fill port of the sample substrate, and filling the sample substrate with the biological sample from the internal volume.

Various embodiments relate to a method for filling a sample substrate. The method may comprise introducing a biological sample in a sample preparation chamber, providing a movable fluid management module having an internal volume and a pathway, transporting the biological sample from the sample preparation chamber to the internal volume, moving the fluid management module to connect the pathway between a source of suction and the sample substrate, applying a substantial vacuum in the sample substrate by the source of suction, moving the fluid management module to connect between the internal volume and the sample substrate, and causing the biological sample to flow from the internal volume to the sample substrate.

It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several exemplary embodiments.

FIGS. 1A and 1B are perspective front and rear views, respectively, of a sample preparation cartridge, according to an exemplary embodiment of the present teachings;

FIGS. 2A and 2B are enlarged fragmental views of the cartridge shown in FIGS. 1A and 1B, illustrating the open and closed states, respectively, of a reservoir valve;

FIG. 3 is a schematic illustrating various components of a sample preparation chamber, according to an exemplary embodiment of the present teachings;

FIG. 4A is a detailed perspective view of a fluid/suction management module, according to an exemplary embodiment of the present teachings;

FIG. 4B is an enlarged cross-sectional view of the fluid/suction management module shown in FIG. 4A along the A-A′ plane;

FIG. 5A is a detailed perspective view of an alternative fluid/suction management module;

FIG. 5B is an enlarged cross-sectional view of the alternative fluid/suction management module shown in FIG. 5A along the B-B′ plane;

FIG. 6A is an enlarged plan view of the sample substrate shown in FIG. 1;

FIGS. 6B and 6C are enlarged partial cross-sectional view of the sample substrate along the 6B plane in FIG. 6A, illustrating a substrate sealing method according to an exemplary embodiment of the present teachings;

FIGS. 7 through 10 are schematics illustrating various operational positions of a fluid/suction management module shown in FIG. 1 for controlling fluid flows within the sample preparation cartridge;

FIG. 11 is a plan view of the upper portion of a sample preparation cartridge having a sample preparation chamber positioned adjacent to the reservoir containers, according to another exemplary embodiment of the present teachings;

FIG. 12 is a schematic top view of a sample preparation cartridge shown in FIG. 11, illustrating the flow paths from a plurality of reservoir containers to a sample preparation chamber;

FIG. 13 is a plan view of the upper portion of a sample preparation cartridge having a sample preparation chamber and a waste collection chamber positioned adjacent to the reservoir containers, according to another exemplary embodiment of the present teachings;

FIG. 14 is a plan view of the upper portion of a sample preparation cartridge having multiple sample preparation chambers, according to another exemplary embodiment of the present teachings;

FIG. 15 is a schematic top view of the sample preparation cartridge shown in FIG. 14, illustrating the flow paths from a plurality of reservoir containers to the multiple sample preparation chambers;

FIG. 16 is a schematic plan view of the upper portion of a sample preparation cartridge, according to another exemplary embodiment of the present teachings;

FIG. 17 is a schematic flow diagram illustrating relative positions of the reservoir containers and the sample preparation chamber with respect to a sample substrate for the exemplary embodiment shown in FIG. 16;

FIG. 18 is a schematic plan view of the upper portion of a sample preparation cartridge, according to another exemplary embodiment of the present teachings; and

FIG. 19 is a schematic flow diagram illustrating relative positions of the reservoir containers and the sample preparation chamber with respect to a sample substrate for the exemplary embodiment shown in FIG. 18.

### DESCRIPTION OF VARIOUS EMBODIMENTS

Reference will now be made in detail to various exemplary embodiments, examples of which are illustrated in the accompanying drawings. Wherever possible, the same reference numbers will be used throughout the drawings to refer to the same or like parts.

For a PCR process, a test sample to be analyzed can be loaded onto a sample substrate having one or more sample chambers. Typically, relatively inexpensive, disposable, readily-available sample substrates, often referred to as “consumables,” are used. These consumables come in a variety of shapes and sizes, such as, for example, tubes, chips, plates, trays, or cards. In order to increase throughput, a biological test sample can be placed on a card-like substrate having a large number of small sample chambers, so that more tests can be performed in a given period of time, while reducing operating costs by requiring less reaction volumes of biological materials. Such a card-like substrate is a spatial variant of the micro-titer plate and is sometimes referred to as a “microcard.” A microcard typically contains 96, 384, or more, individual sample chambers, each typically having a volume of about 1.0 μL or less in a card size of, for example, 7 cm×11 cm×0.2 cm. The number of chambers in a microcard may vary anywhere from, for example, one to several thousands, and the individual chamber volume may vary from, for example, 0.001 μL to 1000 μL.

To analyze a biological sample, the sample is typically mixed with one or more analyte-specific reagents in each of the individual sample chambers and the reaction of the sample with respect to the analyte-specific reagents is detected. These analyte-specific reagents enable detection of a wide variety of analyte classes in the sample. These various reagents can be pre-loaded in each of the sample chambers by the consumable manufacturer to be further loaded with a desired biological sample, or they can be loaded onto a consumable with a desired biological sample at the testing facility by using various sample preparation equipment.

When the sample is prepared at a testing facility using various sample preparation equipments, it generally involves complex, time-consuming, manual operations, including reagent preparation and calibration, pipetting, vortexing, centrifugation, phase separations, and transportation of the sample to various processing and reading equipments. As becomes apparent, a conventional sample preparation includes a variety of potential errors that must be taken into consideration, such as, for example, errors and cross-contamination associated with the set-up of a sample preparation equipment, pipetting process, and plate sealing process. In addition, a possibility of user programming errors or handling errors may arise while transporting a loaded consumable to a thermal cycling or reader device and/or setting up the device for processing or testing.

In order to minimize such errors associated with above-mentioned process or testing, operation and handling of a sample preparation equipment and a consumable must be performed by a highly trained operator. A certain portion of users with limited resources, however, may not be able to afford or justify such a large capital investment relating to extensive training and/or the space required for a more sophisticated, high-volume, high-performance equipment.

Thus, there exists a need for a sample preparation device which can minimize the potential user errors and cross-contamination associated with preparation of a sample, operation and handling of the sample in the associated equipment.

According to an exemplary embodiment of the present teachings, a sample preparation cartridge having an integrated fluid management system for biological sample preparation is provided. The sample preparation cartridge can be used to prepare various biological samples for assays, such as, for example, PCR process. The sample preparation cartridge may contain all the required reagents, a fluid management system, a purification device, a waste management device, and a sample substrate in a single containment structure. In particular, the cartridge having the integrated fluid management system may provide sample preparation equipment with size reduction and simplified operation, which may result in reduced costs relating to manufacturing and operation of the device.

In accordance with the present teachings, the cartridge can be configured to be placed onto a host machine or system which may have auxiliary systems for automatically controlling the operation of the sample preparation cartridge. For example, the host machine may include, but is not limited to, a suction pump, various valve actuators, plunger drive mechanisms, and a bar code reader. In one example, the host machine may be a computer-controlled system with suitable input/output units, such as, for example, a touch-screen display monitor. The various auxiliary systems in the host machine can be controlled by a central processing unit of a computer according to a prescribed sequence of operational events. The host machine can also be equipped with a networking connection so as to allow controlling of the machine from a remote location. In another exemplary embodiment, the host system can be configured for analyzing the results of assays by optical means known in the art of fluorometric imaging.

During operation, for example, a user may insert a sample preparation cartridge onto a host machine and initialize the machine. The host machine then reads the identification code such as, for example, a bar code displayed on a surface of the cartridge and prompts the user to pipette an appropriate biological sample into a sample preparation chamber and to input the sample information if not contained in the identification code. The user may then be prompted to press the start button. The rest of the operation, such as, for example, sample preparation, thermal cycling, and/or sample reading, can be fully automated except the removal of the cartridge from the host machine.

By doing so, the present teachings may allow preparation of one or more sample substrates in a highly automated factory setting for use in smaller labs and field operations. This reduces the possibility of various user errors by automating many operations in a controlled facility and limiting user access to inserting the sample into the sample preparation cartridge.

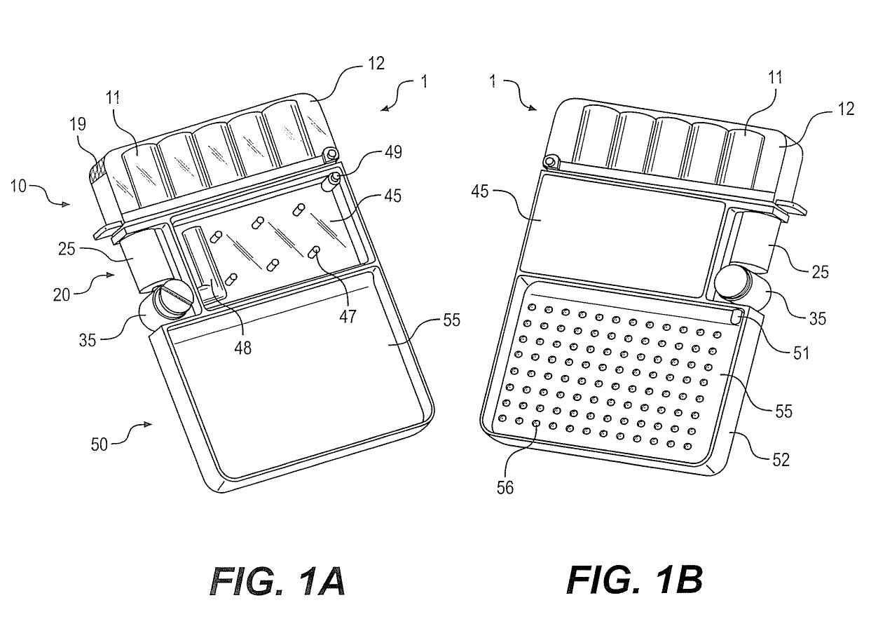

FIGS. 1A and 1B are perspective front and rear views of a sample preparation cartridge 1, according to an exemplary embodiment of the present teachings. For illustration purposes only, the cartridge 1 is divided into three main sections: upper section 10, middle section 20, and bottom section 50. The upper section 10 has a plurality of reservoir containers 11 for storing various chemical solutions such as reagents used for preparation of a biological sample for testing. One of the reservoir containers 11 may contain the biological sample to be tested. While the embodiment depicted in FIG. 1 has five cylindrical reservoir containers 11, the sample preparation cartridge 1 can have any desired number of reservoir containers 11 in any desired shape and size. The cartridge 1 may also include a transparent cover 12 for covering the plurality of reservoir containers 11.

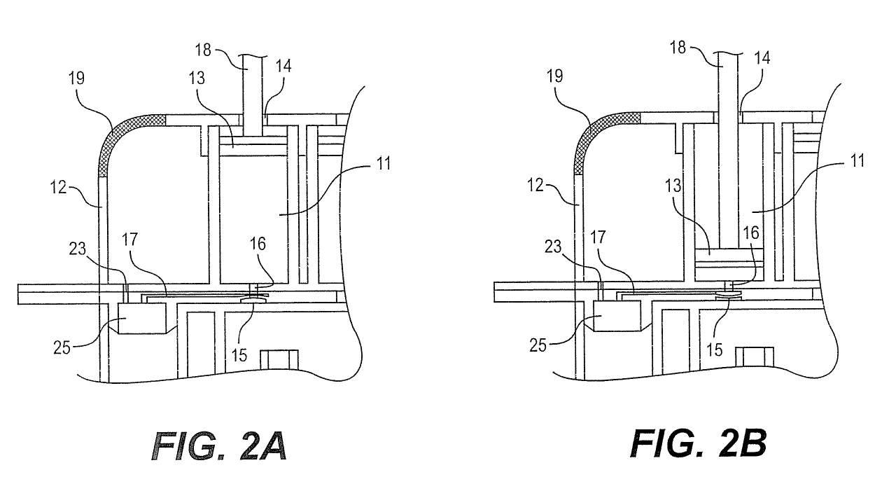

As shown in FIGS. 2A and 2B, each of the reservoir containers 11 may have a piston 13, a reservoir valve 15, a discharge tip 16, and a delivery channel 17. Each reservoir container 11 may also include a filling port (not shown) for filling the container 11 with a desired sample or chemical solutions including reagents. The piston 13 can be axially movable relative to the side wall of the container 11. The piston 13 may be provided with a substantially air-tight seal between the piston 13 and the side wall of the container 11 so that the pressure in the container 11 can be more readily controlled.

The chemical solution in each of the reservoir containers 11 may flow into the sample preparation chamber 25 via the reservoir valve 15 and the delivery channel 17. Each reservoir container 11 may have an individual delivery channel 17 providing fluid connection between respective reservoir container 11 and the sample preparation chamber 25 via the reservoir valve 15. The reservoir valve 15 can be, for example, a normally-closed gate or check valve that can be controlled by a programmable, automated device of a host machine (not shown). The reservoir valve 15 may also be manually operable. In various embodiments, the reservoir valve 15 is a mechanical push valve. For example, when a fluid in the reservoir container 11 is to be delivered to the sample preparation chamber 25, a suitable device in a host machine, such as, for example, a plunger mechanism 18, can be actuated, via an opening 14 formed on the top surface of the transparent cover 12, to push the piston 13 inwardly. As shown in FIGS. 2A and 2B, the piston 13 may be configured to mechanically cooperate with the plunger mechanism 18 of the host machine. Alternatively, in various embodiments, a plunger may be formed integrally with the piston 13. In that instance, the plunger may be configured to cooperate with a suitable driving device disposed in a host machine to axially reciprocate the piston 13 inside the container 11.

The downward displacement of the piston 13 then increases the internal pressure inside the reservoir container 11, forcing the reservoir valve 15 to open, as shown in FIG. 2B, and to align with respect to both of the discharge tip 16 and the delivery channel 17 to permit fluid flow therebetween. In an alternative embodiment, the piston 13, plunger mechanism 18, and reservoir valve 15 may be replaced with a nozzle jet mechanism used in, for example, the bubble or ink jet technology. It should be understood, however, that any other suitable device that induces sufficient differential pressure between the reservoir container 11 and the sample preparation chamber 25 for causing a flow therebetween can be utilized.

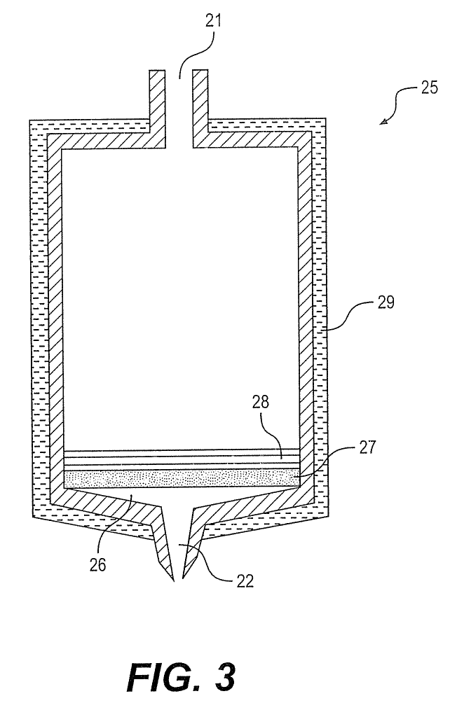

The middle section 20 of the cartridge 1 includes the sample preparation chamber 25, a fluid/suction management module 35, and a waste collection chamber 45. The sample preparation chamber 25 can be of a generally cylindrical column having a plurality of fluid ports (only one port 21 shown in FIG. 3) for connection to each of the delivery channels 17 of the reservoir containers 11. The sample preparation chamber 25 may include a vent opening 23 for venting gaseous components, such as aerosols generated during eluting processes, out of the sample preparation chamber 25. The vent opening 23 may also include a suitable filter element (not shown). The gaseous components vented out of the sample preparation chamber 25 can be vented out to the atmosphere through a filtered opening 19 formed on the cover 12. The sample preparation chamber 25 may also include a sample pipetting port (not shown) at its top surface for delivery of a biological raw sample. A suitable device, such as, for example, a plunger (not shown) can be connected to the sample pipetting port to deliver the raw sample. The term “raw sample” means a sample of biological material prior to a purification process. Once the raw sample is delivered into the sample preparation chamber 25, various chemical solutions including reagents contained in the reservoir containers 11 may flow into the sample preparation chamber 25 for desired processing of the raw sample. The chamber 25 may include a discharge port 22 at the bottom surface of the chamber 25, that is in fluid communication with a fill port of the fluid/suction management module 35.

In accordance with the present teachings, the sample preparation chamber 25 may include a purification system for purifying the biological sample. FIG. 3 shows a schematic cross-sectional view of the sample preparation chamber 25, according to an embodiment of the present teachings. Although FIGS. 1 and 3 show the chamber 25 as being a substantially cylindrical column, it should be appreciated that the chamber 25 can also be of any desired geometrical shape, such as, for example, a rectangular or triangular column or cone. In one embodiment, the side wall of the chamber 25 can be slightly tapered. The chamber 25 may also have a funnel-like configuration in the lower portion of the chamber 25.

In accordance with various exemplary embodiments of the present teachings, the sample preparation chamber 25 may include a filter element 27 and a retention device 28 for securely holding the filter element 27 inside the sample preparation chamber 25, as illustrated in the exemplary embodiment of FIG. 3. The retention device 28 may be an annular ring that can press the filter element 27 down toward the bottom surface of the chamber 25. The funnel-like configuration in the bottom portion of the chamber 25 forms a gap 26 between the filter element 27 and the bottom surface of the chamber 25. This gap 26 allows the majority of the filter element's lower surface to be open and substantially unobstructed flow to occur through the filter element 27. Alternatively, other suitable fastening mechanisms can be provided, such as clamps, stops, etc.

The filter element 27 can be made into a shape of a disc which closely corresponds to the cross-sectional area of the bottom portion of the chamber 25. The filter element 27 may have a variety of thicknesses, sizes, and shapes depending on specific applications. The material and type of filter element 27 depends on the intended use of the purification system. For example, the filter element 27 may serve as a size exclusion filter, while the filter element 27 can serve as a solid phase interaction with a species in the liquid phase to immobilize the species upon contact, such as an immunological interaction or any other type of affinity interaction. Examples of suitable filter materials include, but are not limited to, those of nitrocellulose, regenerated cellulose, nylon, polysulfone, glass fiber, blown microfibers, and paper. Additional examples of suitable filters include microfiber filters of ultra-pure quartz (SiO₂). In another embodiment, the filter element 27 is a porous element that acts as a frit, serving to contain a column packing material.

The sample preparation chamber 25 may also include a heating device configured for providing heat to the liquid in the chamber 25. Typically, heating the liquid sample enables a wider range of filtration processes, however, the sample preparation chamber 25 may not have a heating device. In one embodiment shown in FIG. 3, the heating device may include a heat transfer plate 29 surrounding at least a portion of the outer surface of the chamber 25. In some applications, it may be desirable to provide uniform heating throughout the liquid volume in the chamber 25. In order to provide the uniform temperature, the plate 29 can be made of a high thermal-conductivity material, such as copper and aluminum, and can be connected to a heat source. Alternatively, other types of heating devices, such as, for example, a resistive heater, a liquid bath, and an irradiant light, can be used to provide heat to the liquid.

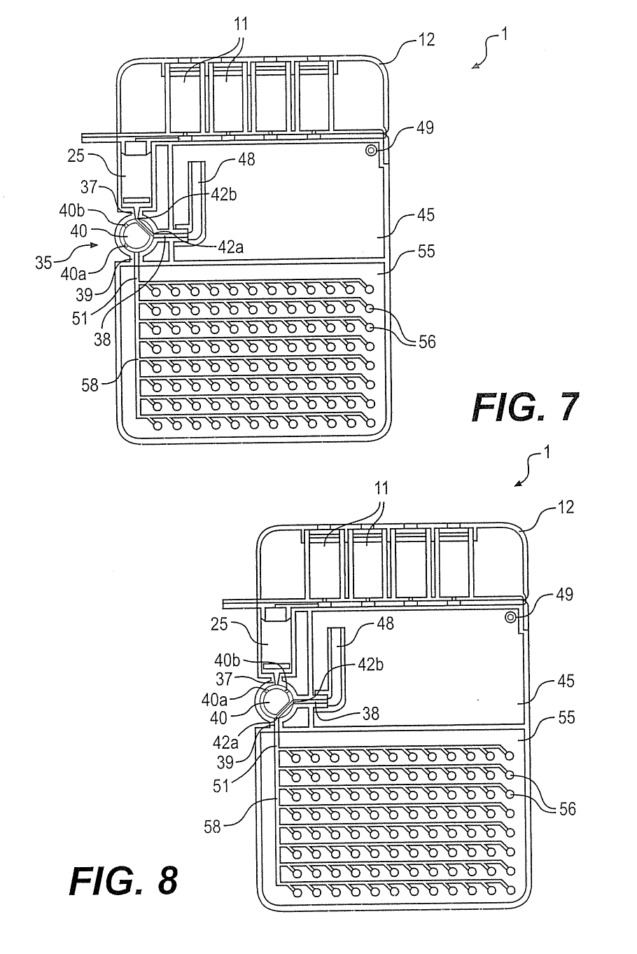

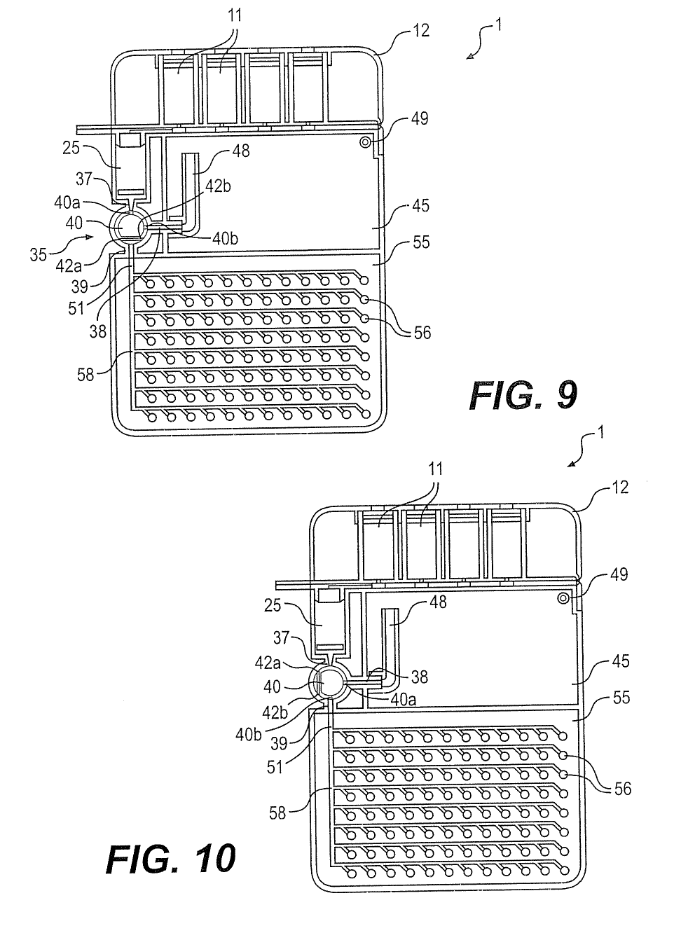

In accordance with various exemplary embodiments of the present teachings, the filter element 27 may be used to purify a raw sample prior to loading onto a sample substrate for analysis. In the sample preparation chamber 25, the raw sample may undergo various sample preparation processes to purify the sample for testing. For example, a series of washes and/or other necessary processes may be performed to the raw sample to remove, for example, a nucleic acid and cellular debris from the sample material. In various exemplary embodiments, removed nucleic acid and cellular debris can be captured or immobilized in the filter element 27. During this process, as will be described in detail below, the fluid/suction management module 25 can be in a suction position, shown in FIG. 7, to direct the wash solutions from one or more reservoir containers 11 to the waste collection chamber 45 through the filter element 27, without accumulating the waste solutions in an internal volume 40 of the fluid/suction management module 35. Once the nucleic acid and cellular debris are sufficiently removed from the raw sample, the fluid/suction management module 35 may rotate approximately 90 degrees to align the internal volume 40 of the module 35 with the discharge port 22 of the sample preparation chamber 25, as shown in FIG. 9. An elution solution may then be allowed to flow into the chamber 25 from a reservoir container 11 so that the purified nucleic acid can solubilize and leave the filter element 27 to be discharged into the internal volume 40 of the module 35. During this eluting process, the degree of suction force can be substantially reduced to permit accumulation of the purified sample in the internal volume 40. The sample so prepared may then be used to fill the sample substrate 55 and undergo any suitable thermal or chemical operation. In various exemplary embodiments, the purification device of the present teachings can be used for any known filtration processes, such as, for example, extraction and purification of RNA or DNA from blood, and extraction and purification of proteins. The purification device of the present teachings can also be suited for purifying specific sequences of DNA and RNA by varying the material of the filter element 27. The basic components of the purification device described above may be similar to a column of a purification tray disclosed in U.S. Pat. No. 6,419,827, assigned to the assignee of the present teachings, the disclosure of which is herein incorporated by reference.

In various exemplary embodiments, the waste collection chamber 45 can be made sufficiently large enough to accommodate various waste generated during various sample preparation processes. As illustrated in FIG. 1, the waste collection chamber 45 has a suction port 49 for connection to a suitable external source of suction, such as, for example, a vacuum pump in a host machine or any other suitable suction mechanisms known in the art. The waste collection chamber 45 can be in fluid communication with the fluid/suction management module 35 via a waste pipe 48. The waste pipe 48 can be bent to have its opening extended above the expected waste level in the waste collection chamber 45 in order to prevent potential backflow of waste material into the fluid/suction management module 35. Since a source of suction is applied to the waste collection chamber 45, the walls of the chamber 45 can be supported by a plurality of support pins 47 or columns to prevent deformation of the volume 45, as shown, for example, in FIG. 1. In one embodiment, the waste collection chamber 45 may be made of a transparent material, such as, for example, polymer material, so as to allow visual observation of the processes during operation.

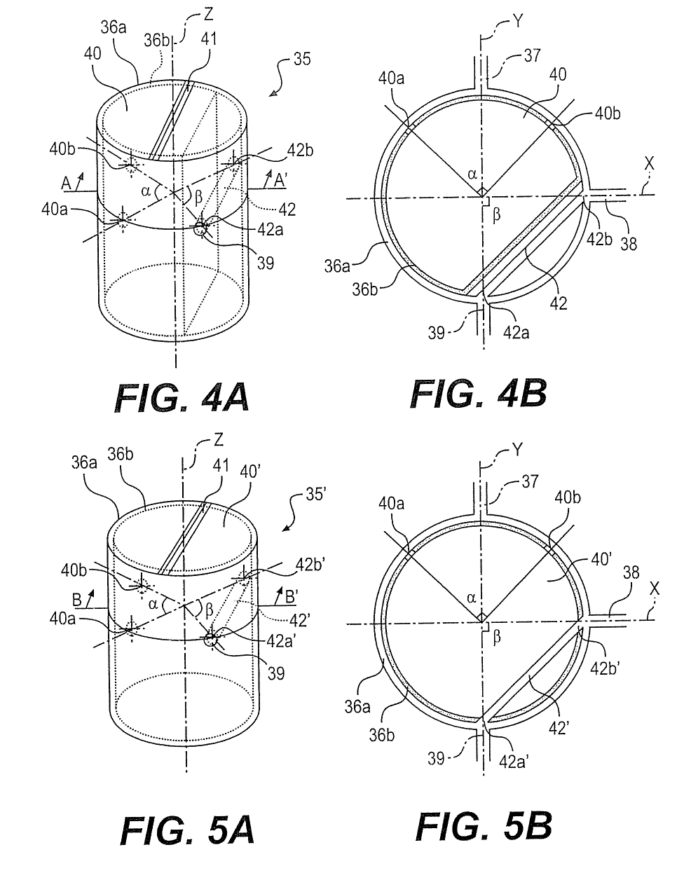

In various exemplary embodiments, the fluid/suction management module 35 can be located immediately below the sample preparation chamber 25. The module 35 can be used to control the direction of the various fluid flows within the cartridge 1. FIG. 4A is a detailed perspective view of a fluid/suction management module 35, according to an embodiment of the present teachings. FIG. 4B shows an enlarged cross-sectional view of the module 35 along the A-A′ plane of FIG. 4A. As shown in FIG. 4B, the module 35 includes an outer housing 36a having three fluid ports: a sample receiving port 37, a waste port 38, and a substrate fill port 39, that are in fluid communication with the sample preparation chamber 25, the waste collection chamber 45, and a fill port of a sample substrate 55, respectively. The module 35 has an inner housing 36b rotatably situated inside an outer housing 36a so that the inner housing 36b can be rotatable inside the outer housing 36a with respect to a rotating axis Z. In various exemplary embodiments, the top of the inner housing 36b includes a screw groove 41 for enabling alternative manual rotation of the inner housing 36b. Alternatively, any other suitable mechanism, such as, for example, a knob or flange, can also be used.

In various exemplary embodiments, the inner housing 36b may include an internal volume 40 having a pair of fluid ports 40a, 40b and a suction path 42 having a pair of suction ports 42a, 42b. As briefly described above, the internal volume 40 is configured to receive the purified sample from the sample preparation chamber 25 after the purification processes The purified sample can then be temporarily stored in the internal volume 40, prior to loading onto the sample substrate 55. The internal volume 40 can be made sufficiently large to hold a predefined volume of the purified sample. The volume and dimensions of the container varies depending on the intended use of the sample and the number and size of the sample chambers 56. For example, the container can be made sufficiently large to hold sufficient volume of sample to fill all of the sample chambers 56.

As shown in FIGS. 4A and 4B, the internal volume 40 is a generally cylindrical volume with a portion cut out to accommodate the suction path 42. The suction path 42 can be a through-bore integrally formed in the inner housing 40b. In an alternative exemplary embodiment shown in FIGS. 5A and 5B, an internal volume 40′ can be a cylindrical volume with a suction path 42′ formed by a pipe passing through the cylindrical internal volume 40′. As shown in FIGS. 4B and 5B, the pair of fluid ports 40a, 40b of the internal volume 40, 40′ can be separated by a substantially perpendicular angle α with respect to the rotating axis of the internal volume 40, 40′. The suction ports 42a, 42b can also be separated by a substantially perpendicular angle β with respect to the rotating axis of the internal volume 40, 40′.

During operation, the inner housing 36b can be rotated relative to the outer housing 36a. The fluid ports 40a, 40b of the internal volume 40 and the suction ports 42a, 42b of the suction path 42 can be selectively aligned with respect to the sample preparation chamber 25, the waste collection chamber 45, and a fill port 51 of the sample substrate 55. As will be described in great detail below, the various fluid and suction flows within the cartridge 1 can be readily controlled by this fluid/suction management module 35.

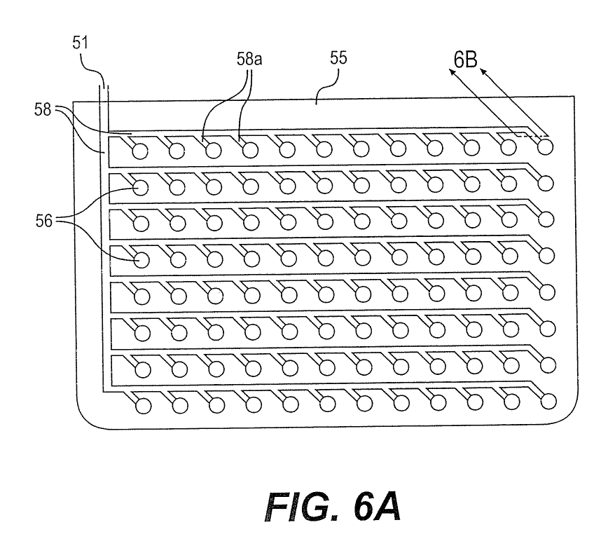

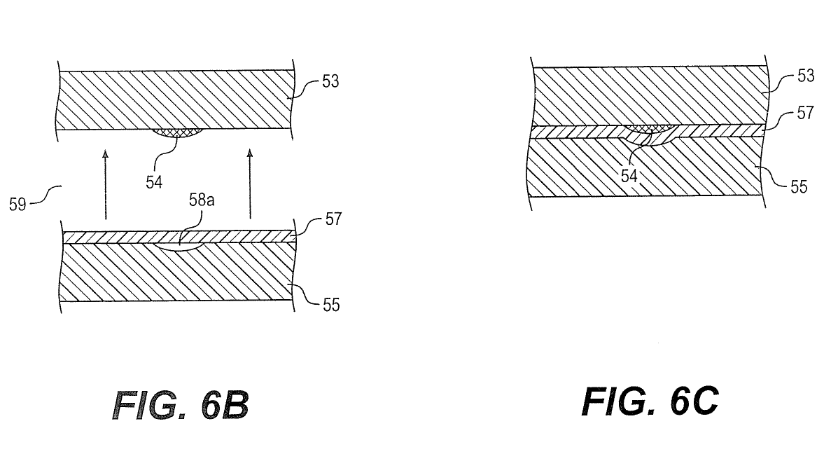

The bottom section 50 of the cartridge 1 includes a sample substrate 55 having a fill port 51 and a plurality of sample chambers 56, as shown in FIGS. 1A and 1B. FIG. 6A shows an exploded view of the sample substrate 55, according to an exemplary embodiment of the present teachings. The substrate 55 may be a spatial variant of the micro-titer plate, having a size, for example, of 60 mm×40 mm×3 mm, and can be configured for placing within a substrate housing 52. The substrate 55 can also be as large as a standard plate format having dimensions of 128 mm×85 mm, or as small as 10 mm×10 mm with approximately 50-100 nL well volumes. The fill port 51 of the substrate 55 can be connected to the fill port 39 of the fluid/suction management module 35 to fill the sample chambers 56 of the sample substrate 55 with the purified sample. Each of the sample chambers 56 can hold a predefined volume of liquid sample, such as, for example, approximately 1 μL. This volume may vary depending on the specific application. The substrate 55 may also include a network of passageways 58 for connecting each of the sample chambers 56 to the fill port 51. The substrate 55 shown in FIG. 6A is a generally rectangular card-type substrate and has 96 sample chambers in 8×12 matrix. However, the substrate 55 may also have any desired number of sample chambers 56 in any desired shape or size. The substrate 55 may also include an integrated chamber lenses (not shown).

Each of the sample chambers 56 can be sealed prior to undergoing various processes. The sealing can be achieved by closing off the loading passages 58a to isolate the individual sample chambers 56. In various exemplary embodiments, the substrate 55 can be brought into a contact with a sculpted thermal transfer block 53 so as to deform the substrate cover 57 and close off the loading passages 58a, as shown in FIGS. 6B and 6C. The substrate housing 52 may include additional support structures to prevent possible warping of the device. The thermal transfer block 53 may include a plurality of bosses 54 or protrusions having a predetermined shape for effectively closing the loading passages 58a. Each of the bosses 54 or protrusions corresponds to the respective sample chamber 56. Each of the bosses 54 can be heated to a prescribed temperature to facilitate deformation of the substrate cover material. In an exemplary embodiment, the sealing is performed in the first thermal cycling step.

In various exemplary embodiments, a suction force can be used to pull the substrate 55 toward the thermal transfer block 53. For example, a source of suction, such as, for example, a vacuum pump, can be connected to the space 59 between the sample substrate 55 and the thermal transfer block 53. As the source of suction force is activated, an imploding force in the space 59 is exerted and, as a result, the sample substrate 55 is pulled toward adjacent to the heated thermal transfer block 53, as shown in FIG. 6C. Due to the heat in the bosses 54 and/or the thermal block 53, the loading passages 58a are deformed to isolate each of the sample chambers 56. In an alternative embodiment, any other suitable mechanisms for bringing the substrate 55 toward the thermal transfer block 53, such as, for example, a spring, can be used. In various exemplary embodiments, conventional scribe method for deforming the passageway 58a can be used.

In accordance to the present teachings, the cartridge 1 can be made of polymer, metal, ceramic, or any combination of materials thereof. In particular, the components that are in contact with the sample and reagents can be made of materials that are water-insoluble, fluid impervious material that is substantially non-reactive with the fluid samples. The cartridge 1 can also be made of material that can also resist deformation or warping under a light mechanical or thermal load, but may be somewhat elastic. The cartridge 1 can also be made of material that can withstand fluctuating temperatures ranging, for example, from 5° C. to 90° C. Suitable materials for the cartridge 1 include, for example, polypropylene, acrylics, polycarbonates, and polysulfones.

According to various exemplary embodiments of the present teachings, operation of the cartridge 1 for preparation of a biological sample is described in detail with reference to FIGS. 7-10. FIGS. 7-10 schematically illustrates major steps of the sample preparation processes performed with various components of the sample preparation cartridge 1. First, the preparation process of a sample is described. In case a raw sample is introduced into the sample preparation chamber 25, the inner housing 36b of the fluid/suction management module 35 can be rotated approximately 90 degrees in clockwise direction to align the suction ports 42a, 42b of the suction path 42 with the sample receiving port 37 and the waste port 38 of the outer housing 36a, respectively, without the fluid ports 40a, 40b being in fluid communication with any of the external ports 37, 38, 39, as shown in FIG. 7. A suitable driving device in the host machine is then actuated to push the piston 13 in the reservoir container 11 to allow a wash solution contained in the reservoir container 11 to flow into the sample preparation chamber 25. The wash solution then mixes with the raw sample in the sample preparation chamber 25, removes a nucleic acid from the raw sample, passes through the filter element 27 leaving the nucleic acid in the filter element 27, and enters into the waste collection chamber 45. A suction can be applied to assist or adjust the flow rate of the waste fluid from the sample preparation chamber 25 to the waste collection chamber 45.

Next, once the nucleic acid is sufficiently removed from the raw sample, the fluid/suction management module 35 can be rotated approximately 90 degrees in the clockwise direction to align the suction ports 42a, 42b of the suction path 42 with the substrate fill port 39 and the waste port 38 of the outer housing 36a, respectively, without the fluid ports 40a, 40b being in fluid communication with any of the external ports 37, 38, 39, as shown in FIG. 8. During this process, the source of suction is applied to the network of passageways 58 and each sample chamber 56 to evacuate their contents to the waste collection chamber 45. As a result, each sample chamber 56 can be maintained with a prescribed degree of vacuum that can be used to fill the chamber 56 with the sample, as will be described below. In an alternative embodiment, a centrifugal filling method or any other well-known methods in the art may be used to fill each of the sample chamber 56.

After the prescribed vacuum is achieved in each sample chamber 56, the fluid/suction management module 35 is turned approximately 45 degrees in a clockwise direction to align the fluid ports 40a, 40b of the internal volume 40 with the sample receiving port 37 and the waste port 38 of the outer housing 36a, respectively, without the suction ports 42a, 42b being in fluid communication with any of the external ports 37, 38, 39, as shown in FIG. 9. At this stage, an elution solution, such as, for example, gDNA precipitation solutions, wash solutions, and elution buffers compatible with all downstream PCR-based applications, may be flown from one or more of the reservoir containers 11, by the similar method described above, into the sample preparation chamber 25. The purified nucleic acid in the filter element 27 can then be solubilized, passed through the filter element 27, and discharged into the internal volume 40 of the fluid/suction management module 35. The purified sample can then be temporarily stored in the internal volume 40.

In various exemplary embodiments, the sample chambers 56 in the sample substrate 55, as shown in FIG. 10, may be filled by rotating the fluid/suction management module 35 approximately 90 degrees in a clockwise direction to align the fluid ports 40a, 40b of the internal volume 40 with the waste port 38 and substrate fill port 39 of the outer housing 36a, respectively, without the suction ports 42a, 42b being in fluid communication with any of the external ports 37, 38, 39. The source of suction can be substantially reduced or completely turned off to allow the purified sample in the internal volume 40 to flow into the sample chambers 56 via network of passageways 58. Since each individual sample chamber 56 is in a prescribed vacuum condition, the differential pressure across each of the sample chamber 56 and the internal volume 40 causes the purified sample in the internal volume 40 to flow into each of the sample chambers 56. During this process, any gaseous components, such as aerosols generated during the eluting process, contained in the internal volume 40 can be vented out to the waste collection chamber 45 or through the vent opening 23 and the filtered opening 19. Alternatively, a “priming” arrangement, described in published PCT International Application, WO 01/28684, the disclosure of which is incorporated herein by reference, can be used for minimizing the presence of gas entering the substrate.

In various exemplary embodiments, after the sample substrate 55 is filled with the sample to be tested, a suitable testing operation, such as, for example, a PCR process, can be performed by the host machine without removing the cartridge 1 or any user intervention. By having such integrated fluid/suction management module 35, significant reductions in equipment size, complexity, and equipment costs are possible. Furthermore, this will provide smaller testing facilities with full sample testing capabilities without extensive training required for operation of conventional sample preparation equipments.

As is clear from the above description, the present teachings include methods of preparing a biological sample. The methods may include preparing and storing the biological sample in a sample preparation chamber, providing a waste collection chamber for storing waste liquid, providing a sample substrate having a fill port, and providing a rotatable fluid management module. The fluid management module may include a first flow path and a second flow path, so that rotating the fluid management module can selectively connect between two of the sample preparation chamber, the waste collection chamber, and the sample substrate in fluid communication via one of the first and second flow paths. The step of preparing the biological sample may include inserting a biological raw sample into the sample preparation chamber. The step of preparing the biological sample may further include providing at least one reservoir container for storing a sample preparation liquid, where the at least one reservoir container is in fluid communication with the sample preparation chamber. The sample preparation chamber may include a purification device for purifying a biological raw sample.

The step of preparing the biological sample may also include flowing the sample preparation liquid from the at least one reservoir container into a sample preparation chamber, passing the sample preparation liquid through the purification device, rotating the fluid management module to connect between the sample preparation chamber and the waste collection chamber via the first flow path, connecting a source of suction to the waste collection chamber, and removing the sample preparation liquid into the waste collection chamber by the applied suction.

The methods may also include providing an internal volume in the second flow path of the fluid management module, rotating the fluid management module to connect the sample preparation chamber with the internal volume, and flowing the biological sample stored in the sample preparation chamber into the internal volume of the fluid management module. The second flow path may connect between the sample preparation chamber and the waste collection chamber when the fluid management module is rotated to connect the sample preparation chamber with the internal volume.

The methods may also include connecting a source of suction to the waste collection chamber, so that the applied suction can cause the biological sample stored in the sample preparation chamber to flow into the internal volume of the fluid management module. The methods may also include rotating the fluid management module to connect the internal volume with the fill port of the sample substrate, and filling the sample substrate with the biological sample stored in the internal volume. Prior to filling the sample substrate, the sample substrate may be applied with a suction. The suction to the sample substrate can be provided by rotating the fluid management module to connect between the sample substrate and the waste collection chamber via the first flow path, connecting a source of suction to the waste chamber, and evacuating the contents in the sample substrate into the waste collection chamber.

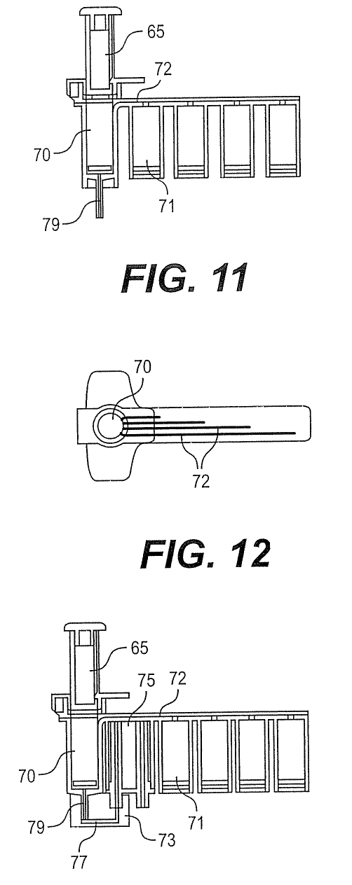

FIG. 11 shows a plan view of the upper portion of a sample preparation cartridge, according to another exemplary embodiment of the present teachings. In this embodiment, the sample preparation chamber 70 can be positioned adjacent to the plurality of reservoir containers 71. The reservoir containers 71 in this embodiment can be substantially identical to those of the embodiment shown in FIGS. 2A and 2B, except that the reservoir containers 71 in this embodiment can be positioned such that the delivery channels 72 can be disposed on the top surface of the reservoir containers 71. The sample preparation chamber 70 may include a plunger device 65 for pipetting a biological raw sample into the chamber 70. The plunger device 65 may also be used to create differential pressure across the sample preparation chamber 70 and the reservoir containers 71 for pulling the chemical solutions from the reservoir containers 71 into the chamber 70. The rest of the basic components of the sample preparation chamber 70 can be substantially identical to those of the sample preparation chamber 25 shown in FIG. 3.

In various exemplary embodiments, chemical solutions including reagents can flow from the reservoir containers 71 into the sample preparation chamber 70, as shown in FIG. 12, by pulling the plunger device 65 to create a suitable differential pressure between the sample preparation chamber 70 and the respective reservoir containers 71. FIG. 12 shows a top view of the delivery channels 72 extending from the reservoir containers 71 to the sample preparation chamber 70. The remainder of the sample preparation processes can be substantially identical to those described above with reference to FIGS. 1 through 10.

FIG. 13 shows a plan view of the upper portion of a sample preparation cartridge, according to another exemplary embodiment of the present teachings. The sample preparation cartridge in this embodiment is substantially identical to the embodiment described above with reference to FIG. 11, except that a waste collection chamber 75 can be positioned adjacent to the sample preparation chamber 70 and the reservoir containers 71. The cartridge may include a removable block 73 providing an U-shaped flow track 77 for guiding the waste fluid generated in the sample preparation chamber 70 during, for example, washing processes into the waste collection chamber 75. After washing processes are completed, the removable block 73 can be removed from the discharge port 79 of the sample preparation chamber 70 and the purified sample can be directed to a fluid management module (not shown) or to a sample substrate (not shown) with an eluting process.

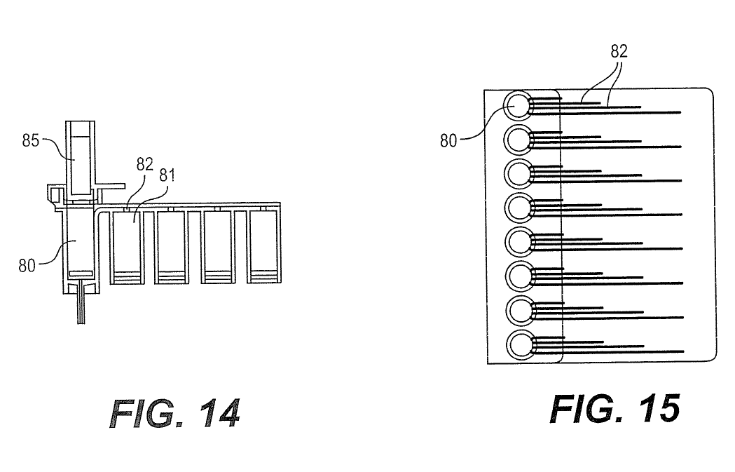

FIGS. 14 and 15 show a sample preparation cartridge having multiple sample preparation chambers 80, according to another exemplary embodiment of the present teachings. While the embodiment shown in the figures have a total of eight sample preparation chambers 80, it should be contemplated that any desired number of chambers 80 can be used. As shown in FIG. 15, the sample preparation cartridge can be used to fill multiple number of sample substrates or a single substrate with multiple isolated fill ports so that different samples can be simultaneously tested in a single testing process.

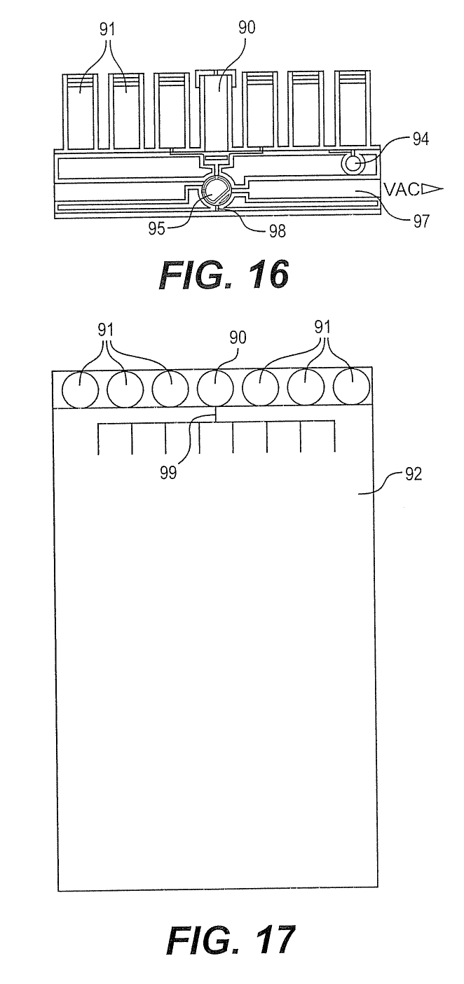

FIG. 16 shows a schematic plan view of the upper portion of a sample preparation cartridge, according to another exemplary embodiment of the present teachings. FIG. 17 shows a schematic flow diagram illustrating relative positions of the reservoir containers 91 and the sample preparation chamber 90 with respect to a sample substrate 92 for the embodiment shown in FIG. 16. The sample substrate 92 shown in FIG. 17 can have any configuration, for example, a similar design as shown in FIG. 6 or any conventionally known designs in the art. In this embodiment, the sample preparation chamber 90 can be positioned adjacent to the reservoir containers 91 in the center portion of the cartridge. Accordingly, a fluid/suction management module 95 can be positioned in the center portion of the cartridge immediately below the sample preparation chamber 90. The substrate fill port 98 of the fluid/suction management module 95 may then be connected to a fill port 99 of the sample substrate 92. Furthermore, a waste collection chamber in this embodiment can be separated externally from the cartridge. For that reason, a suction port 97 for connection to a source of suction can be disposed in a flow path between a fluid/suction management module 95 and the waste collection chamber. The cartridge may also include a temporary storage valve 94 used as an alternative reservoir valve. The valve 94 can temporarily store fluid from a reservoir container 91 and can stop and start flow according to a prescribed condition.

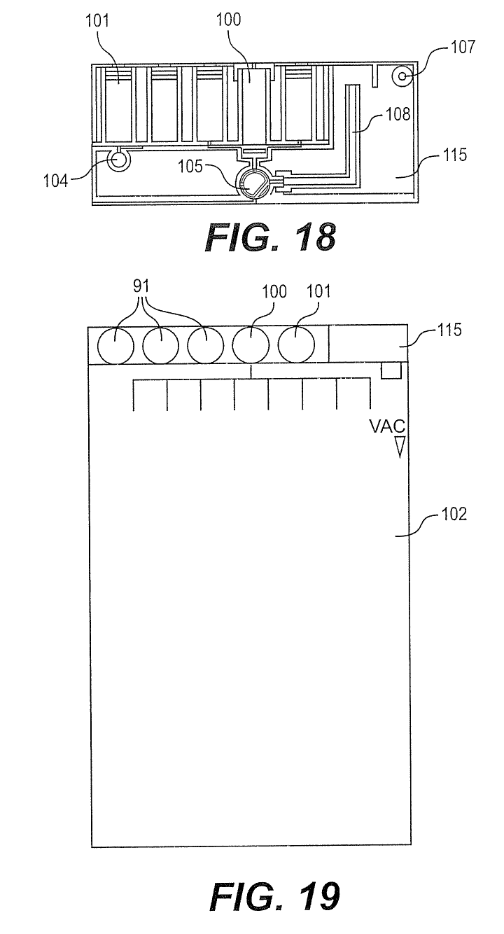

FIG. 18 shows a schematic plan view of the upper portion of a sample preparation cartridge, according to another exemplary embodiment of the present teachings. FIG. 19 shows a schematic flow diagram illustrating relative positions of the reservoir containers 101 and the sample preparation chamber 100 with respect to a sample substrate 102 for the embodiment shown in FIG. 18. The embodiment shown in FIGS. 18 and 19 are similar to the embodiment shown in FIGS. 16 and 17, except that the cartridge can have an integrally formed waste collection chamber 115 that extends from the middle portion to the upper portion of the cartridge. In this embodiment, the waste collection chamber 115 may occupy the volume that can be otherwise occupied by one or more reservoir containers 101.

Other embodiments of the present teachings will be apparent to those skilled in the art from consideration of the specification and practice of the teachings disclosed herein. Various modifications and variations can be made to the structure and methods described above. It is intended that the specification and examples be considered as exemplary only, with a true scope and spirit of the teachings being indicated by the following claims.

1. A biological sample preparation system, comprising:
a sample preparation chamber comprising a biological sample;
a waste collection chamber for storing waste liquid;
a sample substrate; and
a fluid management module for selectively connecting between two of the sample preparation chamber, the waste collection chamber, and the sample substrate in fluid communication.

2.-47. (canceled)
